(19) United States
(12) Patent Application Publication
(10) Pub. No.: US 2017/0076318 A1
(43) Pub. Date: Mar. 16, 2017

(54) ENHANCED CONTENT QUALITY USING CONTENT FEATURES

(71) Applicant: Microsoft Technology Licensing, LLC, Redmond, WA (US)

(72) Inventors: Abhishek Goswami, Bellevue, WA (US); Rohit Paravastu, Bellevue, WA (US); Wen Ding, Bellevue, WA (US); Woohee Kwak, Bellevue, WA (US)

(73) Assignee: Microsoft Technology Licensing, LLC, Redmond, WA (US)

(21) Appl. No.: 14/856,236

(22) Filed: Sep. 16, 2015

(51) Int. Cl. G06Q 30/02

(52) U.S. Cl. CPC G06Q 30/0245; G06Q 30/0269; G06Q 30/0276

(57) ABSTRACT

Architecture that includes an automated content recommendation engine to enhance the quality of content being delivered, and machine learning for the content recommendation. Content recommendation is improved for users and the dissatisfaction rate of displayed content lowered, thereby improving the overall user experience. More specifically, the architecture enables and obtains direct user feedback (e.g., like/dislike) and crowdsourced user feedback of the content, merges content features with the user feedback to build the content recommendation engine, uses the content recommendation engine to detect other content that the user may like or dislike, and, thereby reduces the DSAT rate of display content using the content recommendation engine.

### BACKGROUND

Current techniques for content (e.g., advertisement) recommendation fail to account for content quality. In some cases, the content that gets served is based on user targeting profiles. In other cases, the content selection is performed in an ad-hoc manner. In most of these scenarios, there is little or no attention paid to the quality of the content that gets delivered. This results in a high DSAT (dissatisfaction) rate of the displayed content, and lowers the user experience overall.

### SUMMARY

The following presents a simplified summary in order to provide a basic understanding of some novel implementations described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture includes automated content recommendation systems and methods that rate content (e.g., advertisements). The content recommendation architecture improves content recommendations for users and lowers the DSAT (dissatisfaction) rate of displayed content by delivering high quality content (e.g., advertisements) while automatically eliminating poor quality content (e.g., advertisements), thereby improving the overall user experience.

More specifically, in terms of systems, the content recommendation architecture enables and processes user feedback of content, generally, and direct user feedback (like/dislike) of the content, specifically. The phrase “user feedback” is intended to generally encompass direct user feedback by an individual (crowdsourced and non-crowdsourced person), as well as at least the case where crowdsourced feedback can be aggregated (consolidated) as a single input to the content recommendation architecture. Thus, individual instances of direct user feedback from the many users of a crowd can be aggregated into a single score for each feature on which feedback is requested or a global score for the entire set of features for which feedback is requested.

The content recommendation architecture also merges content features with the user feedback to build the content recommendation system, uses the content recommendation system to detect other content that the user may like or dislike, and, thereby reduces the DSAT rate of display content using the content recommendation system.

In terms of advertising content, the architecture enables improved advertisement recommendations for users and lowered DSAT rate of displayed advertisements, thereby improving the overall user experience. More specifically, the disclosed architecture (a) determines user feedback (e.g., like/dislike for direct user feedback) on the advertisement, (b) merges the advertisement features with the user feedback to build an advertisement recommendation engine, (c) uses the advertisement recommendation engine to detect other advertisements that the user may like (positively interact with) or dislike (negatively interact with), and, (d) reduces the DSAT rate of display advertisements using the advertisement recommendation engine.

More specifically, and in terms of the content being advertisements, the advertisement features (e.g., represented by an n-dimensional advertisement-feature score vector) are used to build the recommendation engine. The features for an advertisement represent the information about the advertisement (e.g., using data from advertisers, industry, advertisement keywords, advertisement landing page, etc.). The advertisement features are merged with the direct user feedback mechanism to build the recommendation engine.

The automation aspect predicts the satisfaction/dissatisfaction ratings of related content. Machine learning can be employed to infer the scores of related content.

In one implementation, a content recommendation system is provided, comprising: a content features component configured to enable assignment of features to a piece of content; a feedback component configured to automatically submit the piece of content and the features to a direct user feedback system and receive direct user feedback about the piece of content; a scoring component configured to generate a score for the piece of content based on the direct user feedback; a quality component configured to compute content quality of the piece of content based on the score; and, a score consolidation component configured to consolidate feature scores of the features and to generate the score.

In another implementation, a content recommendation method is provided, comprising acts of: automatically submitting an item of content and features of the item of content to a crowdsourcing system; receiving direct user feedback about the item of content from the crowdsourcing system; generating a score for the item of content based on the direct user feedback; computing content quality of the item of content based on the score; and recommending a new item of content based on the content quality.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a content recommendation system in accordance with the disclosed architecture.

FIG. 2 illustrates the features that can be utilized for user feedback of the content.

FIG. 3 illustrates a scoring pipeline of advertisement scoring using an integrated crowd-based system.

FIG. 4 illustrates an automatically-generated human intelligent task visual that can be created and submitted to the scoring pipeline of FIG. 3.

FIG. 5 illustrates an automatically-generated HIT visual that can be created for a specific publisher application and submitted to the scoring pipeline of FIG. 3.

FIG. 6 illustrates a content recommendation method in accordance with the disclosed architecture.

FIG. 7 illustrates an alternative method in accordance with the disclosed architecture.

FIG. 8 illustrates a block diagram of a computing system that executes content recommendation in accordance with the disclosed architecture.

### DETAILED DESCRIPTION

There are myriad pieces of content (e.g., advertisements) being served daily across a host of products and platforms (e.g., Outlook.com®, MSN®, Skype®, etc.). In online advertising, for example, the visual appearance of advertisements plays a critical role in influencing the user response—a visually appealing (“good quality”) advertisement can provide improved performance in attracting online users. On the other hand, “poor quality” advertisements degrade both user experience and publisher vendor brand value. The problem is further exacerbated when third-party advertisements are allowed to be served (e.g., on publisher properties) through an exchange. This further reduces control over the advertisements that get delivered. Thus, advertisement quality is paramount for publisher entities (vendors) in order to continue investing and partnering in display advertising initiatives.

The disclosed architecture improves the quality of content such as advertisements by quantifying the quality and visual appearance at scale. The architecture also takes into consideration the context of the publisher application (the specific application of a vendor) in which the content is being delivered.

In the context of the content being advertisements, the advertisements are scored along with the associated visual features. The visual features can fall into categories of global features (to represent the overall advertisement quality), local features (to represent the properties of specific parts within a given advertisement), and contextual features (to represent the visual appearance of the advertisement in the context of the publisher application).

The architecture is made scalable by the development of automated pipelines which invoke crowdsourced systems (e.g., UHRS, ClickWorkers™, etc.) to score advertisements along several visual features. Subsequently, the scores are combined for identifying poor quality advertisements (“low scores”) and/or providing feedback to the designers regarding the advertisement quality, etc.

The automated pipelines invoke crowdsourcing systems in realtime to score the advertisements based on the associated visual features, which enables the scoring (e.g., “higher” scores versus “lower” scores, using some threshold criteria) of the advertisements based on how the advertisements are perceived in the marketplace. The poor quality advertisements are prevented from being delivered, which protects publisher (vendor) brand value. The disclosed architecture enables a recommendation to designers in the advertisement creation process. Designers can get feedback on the advertisements created, thereby enabling the designers to iterate and produce visually appealing advertising.

As previously indicated herein, the architecture is scalable, and enabled by pipelines which can handle the myriad advertisements served daily across several platforms. The architecture also enables publisher-centric visual feature selection and scoring, and also considers the context of the publisher application (e.g., Skype, Outlook, etc.) where the advertisement is being delivered. This takes into account several aspects such as, for example, the size of the advertisement, the advertisement position on the webpage, etc. Moreover, this gives individual publisher people the capability to specify criteria for advertisement quality.

The disclosed architecture improves content (e.g., advertisement) quality using visual features of advertisements, and utilizes direct user feedback such as from crowdsourcing, to provide content recommendations. The recommendation architecture collects content features such as content keywords, landing page information, etc., obtains direct user feedback on the content, receives and processes negative and positive user feedback on the content, trains a content recommendation system based on the direct user feedback on the content, uses the content recommendation system to detect other content the user may like or dislike, and thereby reduces the dissatisfaction (DSAT) rate of display content (e.g., advertisements) using the content recommendation system.

This enables the serving of advertisements, for example, which users are most likely to approve (or “like”) and the suppression of advertisements which users are most likely going to disapprove (or “dislike”). This selectivity of quality content improved the overall user experience.

A content feedback algorithm is configured and provided that is a direct response mechanism which captures user input in the form of positive feedback (e.g., a “like” response) and negative feedback (e.g., a “dislike” response) on a given piece of content such as an advertisement. The user input data can be stored as the following tuple:

<Time, UserID, CreativeID, Response>

where Time is the time of response by the user (e.g., milliseconds, seconds, etc.), UserID is user identification data, CreativeID is an identifier created and assigned to an item or piece of content (also referred to as a “creative”), and, Response is the direct user feedback in the form of a value (e.g., binary) such as zero or one, where zero can be dislike and one can be like.

The satisfaction/dissatisfaction ratings of related content can be inferred using machine learning. In terms of advertisements, the problem can be formulated as a latent-factor collaborative-filtering problem, and use matrix factorization to solve the problem. In one implementation, matrix factorization characterizes the advertisement and the users as vectors of factors inferred from the direct user feedback (e.g., crowdsourcing). Once the model has been learned using such techniques, the user rating on previously unrated advertisement content can be predicted using the inner product (from linear algebra) of the user vector and the advertisement feature vector. A suitable score of this inner product, as can be determined against some threshold score, leads to a recommendation. The same model could also be used to predict related advertisements.

The disclosed architecture exhibits technical effects rooted in computer technology to overcome problems specifically occurring in the realm of computer systems and networks. More specifically, the architecture enables the utilization of crowdsourcing (user feedback from many different users) from myriad other users in an extremely short period of time and from many different geographical locations, to enhance content quality, such as for advertisements, for example. The capability of utilizing direct user feedback via crowdsourcing significantly improves the likelihood of users reacting favorably to content presented, whether via browsers, applications, or the like, and the added capability to then learn and predict new content that users may then like in the future.

Additionally, the disclosed architecture comprises mechanisms that enable the adaptation of the content for different publisher application contexts (e.g., Skype, Outlook). That is, a piece of content can be automatically fitted (e.g., dimensioned, located, positioned, oriented, activated, animated, etc.) into the user interface of a specific publisher application along with automatically-prepared and presented user feedback questions/requests/interactions as to specific features of the content in that given user interface. The direct user feedback as to the questions/requests and user interactions if interacting with the content is then returned and learned by the disclosed architecture for predicting the satisfaction/dissatisfaction of new content that can be selected and employed. This presentation to and feedback from publishers (e.g., people whose goal is to assess the overall visual appeal of content in a given application such as designers, developers, etc.) can occur concurrently with many publishers residing on or accessing one or more networks spanning the same or different geographical locations.

Reference is now made to the drawings, wherein like reference numerals are used to refer to like elements throughout. In the following description, for purposes of explanation, numerous specific details are set forth in order to provide a thorough understanding thereof. It may be evident, however, that the novel implementations can be practiced without these specific details. In other instances, well known structures and devices are shown in block diagram form in order to facilitate a description thereof. The intention is to cover all modifications, equivalents, and alternatives falling within the spirit and scope of the claimed subject matter.

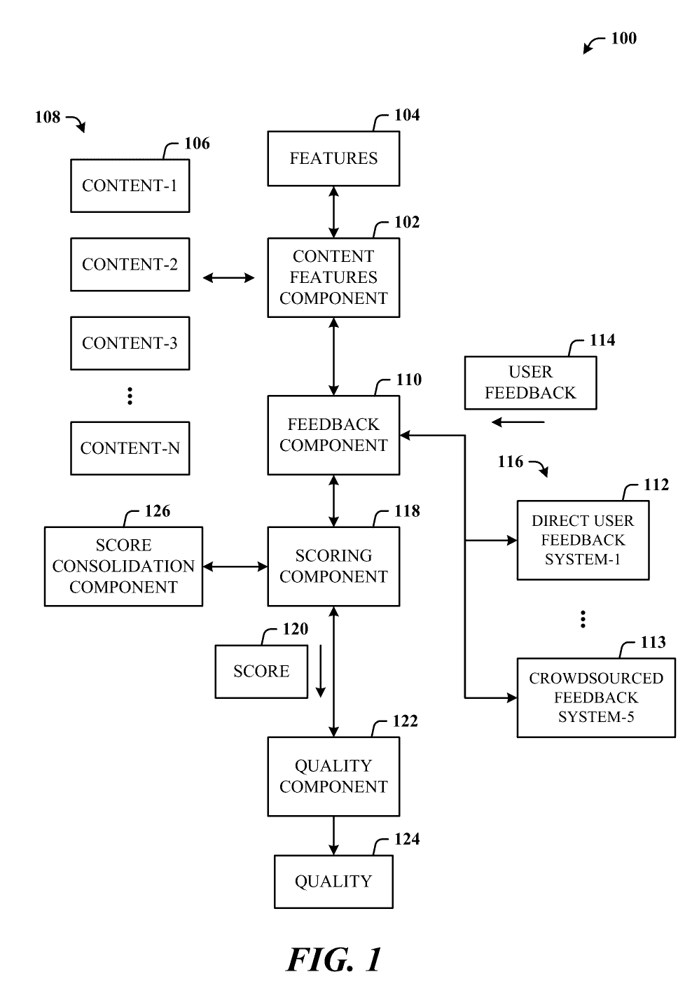

FIG. 1 illustrates a content recommendation system 100 in accordance with the disclosed architecture. The content recommendation system 100 can include a content features component 102 configured to enable assignment of features 104 (e.g., visual, audio, animation, textual, etc.) to a piece of content 106 (e.g., Content-1 of multiple pieces of content 108, denoted Content-1 . . . Content-N, where N is an integer). The content 108 can be located in many different places such as local to a computing system and/or on nodes of a network such as an enterprise and the web.

In one implementation, the content 106 is strictly visual such as a graphic and/or image advertisement and thus, the features 104 relate only to visual properties of the content 106. In yet other implementations, the content 106 is alternatively or includes one or more other content types such as audio content, video content, textual content, or any combinations of various media types (e.g., audio, video, textual, images, video, animation, active links, etc.).

A feedback component 110 is provided and configured to automatically submit the piece of content 106 and one or more of the features 104 to user feedback systems 116, which comprise one or more direct user feedback systems (e.g., a direct user feedback system 112) and one or more crowdsourced user feedback systems (e.g., a crowdsourced feedback system 113), and receive user feedback 114 (e.g., direct feedback and/or crowdsourced feedback (aggregated or otherwise)) about the piece of content 106 from one or more of the user feedback system 116. The crowdsourced feedback system 113 can be a network node where multiple users choose to provide individual feedback as to the likeability or the non-likeability of the content 106 and/or the crowdsourced feedback system 113 receives the direct user feedback from the individuals of the crowd, and then aggregates the direct user feedback of the crowd into one or more values or pieces of data suitable for use by the feedback component 110. For example, the user feedback 114 can be in the form of responses to one or more questions or statements about specific features 104 of the content 106.

A scoring component 118 is provided and configured to generate a score 120 for the piece of content 106 based on the user feedback 114. The score can be a value between zero and one, for example. Where the content is an advertisement, domain knowledge in advertisement understanding can be used to create an n-dimensional advertisement-feature score vector for each advertisement. Information present in advertisements such as advertiser name, industry, advertisement keywords, etc., can be used in the score vector. In the advertisement-feature score vector (or more generally, content-feature score vector for content) each dimension represents a feature. In one implementation, machine leaning can be employed to infer the features score of related content.

The scoring component 118 can further comprise or be associated with a score consolidation component 126 provided and configured to consolidate feature scores of the features and to generate the score used to determine content quality.

A real valued score between [0,1] can be assigned for each feature. The feature score represents how closely the feature relates to the advertisement. For example, an advertisement may have scores, as follows: [Overall Likeness: 0.9, Offensive Content: 0.2, and so on]. In other words, the scoring component 118 can be configured to score the piece of content 106 based on a feature score vector of various categories.

A quality component 122 is provided and configured to compute content quality 124 of the piece of content 106 based on the score 120. For example, the score 120 can be computed on all features or one or more of the features in the feature score vector.

The feedback component 110 submits the piece of content 106 in an application user interface in which the piece of content 106 can be used. That is, the content 106 can be submitted to the one or more sources of user feedback systems 116 (e.g., direct and/or crowdsourced) in the user interface of any given application so the viewer can see how the content looks in the application user interface.

It is to be appreciated that a single application can have several different user interface views, and that the disclosed architecture can insert the content to be judged in any of multiple possible application user interface views. The feedback component 110 can submit the piece of content 106 to one or more of the direct user feedback systems and one or more of the crowdsourced feedback systems of the feedback systems 116.

Thus, the content features component 102 can be configured to consider application-centric features of an application user interface in which the piece of content 106 can be displayed. The content quality 124 is interpreted (e.g., based on a quality threshold) to eliminate lower quality content and retain higher quality content. Thus, prediction by the recommendation system enables “bad” content to be prevented from display, and “good” content to be allowed for display. The content features 104 comprise at least one of global features that represent overall content quality, local features that represent specific parts within a given user interface, or contextual features that represent visual features in context of a publisher application.

It is to be understood that in the disclosed architecture, certain components may be rearranged, combined, omitted, and additional components may be included. Additionally, in some implementations, all or some of the components are present on the client, while in other implementations some components may reside on a server or are provided by a local or remote service.

For example, the content features component 102, the feedback component 110, the scoring component 118, and the quality component 122 can be combined in any desirable combination suitable for the given implementation.

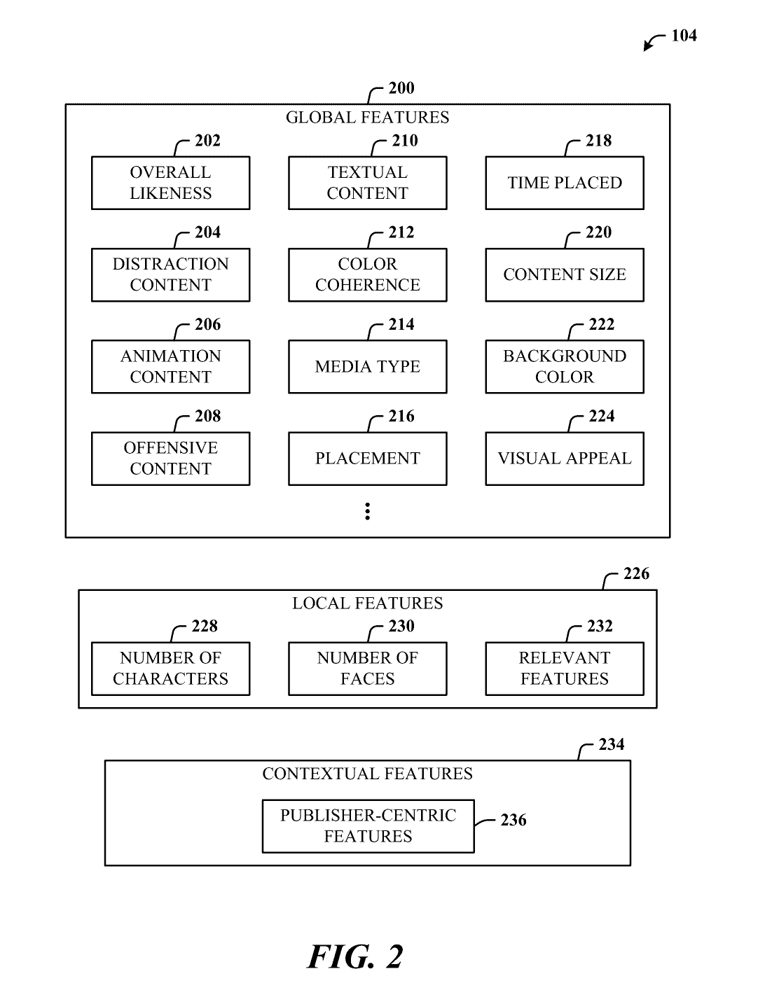

FIG. 2 illustrates the features 104 that can be utilized for user feedback of the content 106. The features 104 created and obtained can be designed to represent content (e.g., advertisements) at a global level, local level, and a contextual level. The global features 200 that represent the specific piece of content at the global level, include but are not limited to, overall likeness 202, distraction content 204, animation content 206, offensive content 208, text content 210, color coherence 212, media type 214 (e.g., audio, video, image, text, etc.), placement 216, time placed 218, content size 220, background color 222, and visual appeal 224, for example.

Associated with each of the global features 200 can be a score. Thus, the scores include an overall likeness score, distraction content score, animation content score, offensive content score, text content score, color coherence score, media type score (e.g., audio, video, image, text, etc.), placement score, time placed score, content size score, background color score, and visual appeal, for example.

The local features 226 represent the properties of specific parts within the content, including but are not limited to, the number of characters 228, number of faces 230, and relevant features 232, for example. Similar to the above scoring, associated with each of the local features can be a score. Thus, in this example, the scores include a number of characters score, number of faces score, and relevant features score.

Contextual features 234 represent the visual appearance of the content in the context (environment) of the publisher application, and include publisher-centric features 236. The publisher-centric features 236 can relate to how the content is presented in the user interface (UI) of the publisher application, media type(s) presented in the UI, the coloration of the content in the UI, location in the publisher application UI, and so on. As before, associated with each of the contextual features 234 is a score.

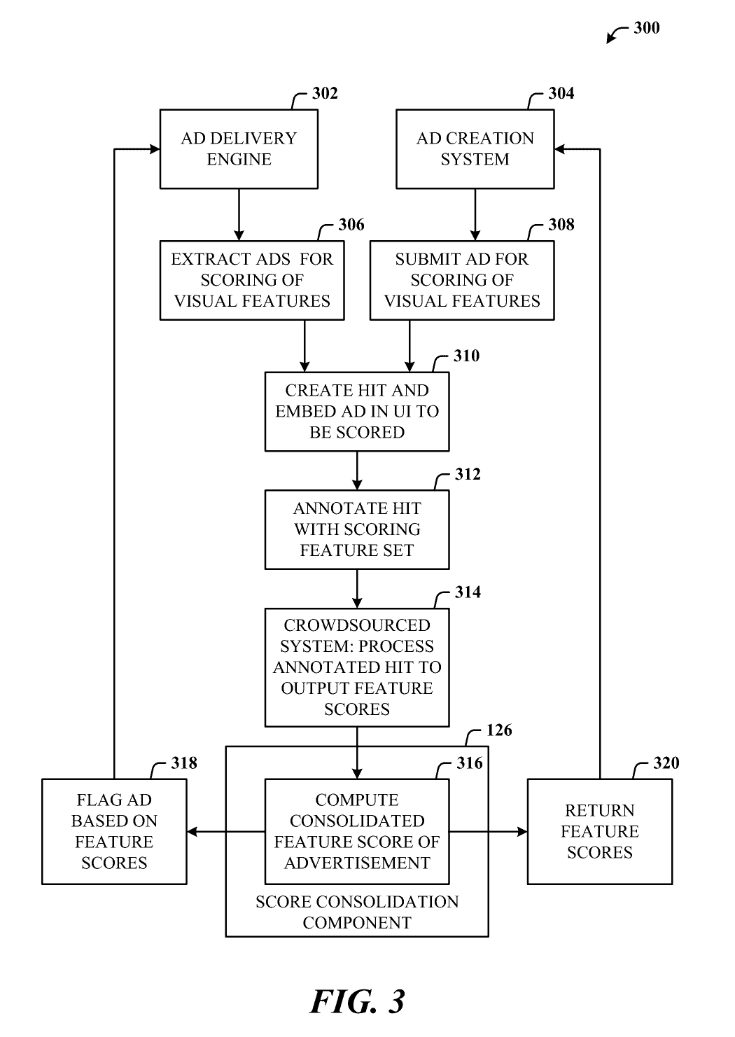

FIG. 3 illustrates a scoring pipeline 300 (also referred to as a likeability pipeline) of advertisement scoring using an integrated crowd-based system (e.g., UHRS-Universal Human Relevance System by Microsoft Corporation). Although described in the context of advertisements, it is to be understood that the pipeline 300 can also be applied more generally to content (e.g., advertising and non-advertising).

Advertisements can be scored using the visual features mentioned above. A set of advertisements is received (delivered from an advertisement delivery engine 302—“the delivery side”). Additionally, the capability is provided where designers can submit advertisements (denoted as the advertisement creation system 304—“the creation side”) for scoring to obtain input from a pool of crowdsourced anonymous human judges.

On the delivery side, flow begins with the advertisement delivery engine 302, which serves advertisements to publisher applications such as Skype®, Outlook®, etc. At 306, advertisements are obtained from the engine 302 for scoring using visual features of each extracted advertisement. The scoring is performed based on one or more visual features selected for each advertisement. On the creation side at 308, advertisement creators submit advertisements for scoring. Again, the scoring is performed based on one or more visual features selected for each advertisement.

At 310, one or more human intelligent tasks (HITs) are created, so that each advertisement can be embedded in the context of the publisher (application) user interface (UI) in which the advertisement should be scored. At 312, the HIT is annotated (tagged) with the set of features for which the advertisement should be scored. The annotated HIT is then submitted to a crowdsourced system 314 of human judges for processing to output feature scores. Each output feature is normalized to have a normalized score.

Once the results are obtained from the crowdsourced judges, appropriate action is taken. More generally for example, if a set of advertisements is submitted to the likeability pipeline for flagging “offensive” advertisements, then the likeability pipeline uses the “offensive-content score” to identify (tag) a list of such offensive advertisements, as indicated at 318. More specifically, at 316, the results from the crowdsourced system 314 are computed into a consolidated feature score for each advertisement. The crowdsourced system 314 can be polled (e.g., by external systems such as a feature consolidation component) to retrieve the feature scoring results. At 318, the list is then provided back to the advertisement delivery engine 302, which subsequently eliminates the offensive advertisements from delivery. The list is processed by the delivery engine 302 to then stop serving any advertisements on the list. Alternatively, or in combination therewith, at 320, the feature scores are returned back to the advertisement creation system.

The score consolidation component 126 creates a consolidated score by combining the above feature scores (e.g., visual). In one example implementation, a weighted-average can be employed to combine all the scores obtained from the pipeline above.

$$\tilde{x} = \frac{{w}_{1} {x}_{1} + {w}_{2} {x}_{2} + … + {w}_{n} {x}_{n}}{{w}_{1} + {w}_{2} + … + {w}_{n}}$$

The weights (w₁+w₂+ . . . +wₙ) are configurable and are often set by the publisher person based on the importance the publisher person associates with each particular feature (e.g., Outlook can receive a very high weight on a “distraction-content” score.

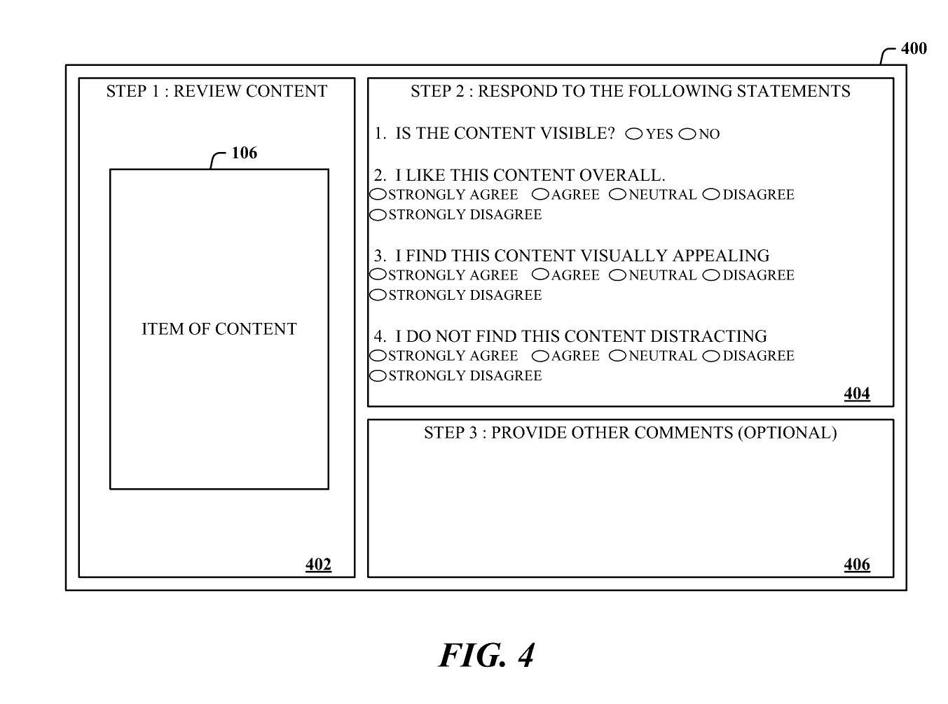

FIG. 4 illustrates an automatically-generated human intelligent task (HIT) visual 400 that can be created and submitted to the scoring pipeline 300 of FIG. 3. The task visual 400 presents three steps in three corresponding boxes the user is requested to complete for a given piece of content (e.g., content 106). The task visual 400 is organized to guide the user through the three steps in an ordered manner. In a first box 402, the item of content 106 is presented for viewing by the user. Additionally, the first box 402 includes textual instructions (e.g., “Step 1: Review Content”) to inform the user as to what to do. In this instance, the user is requested to review the item of content 106.

In a second box 404, the statements one through four are presented for viewing and response (feedback) by the user. Additionally, the second box 404 includes textual instructions (e.g., “Step 2: Respond to the Following Statements”) to inform the user as to what to do. In this instance, the task visual 400 requests user feedback on four statements, three of which are global features: overall likeness (for statement two), visual appeal (for statement three), and distraction (for statement four).

In this particular implementation, the feedback for statements two through four is in the form of five responses: Strongly Agree, Agree, Neutral, Disagree, and Strongly Disagree, and for statement one (content visibility) as Yes or No. Scoring can be computed for each response individually, or each response and associated feature combined. For example, the overall likeness feature of statement two can be weighted the same or differently than the visual appeal feature of statement three. Additionally, the scoring of the Neutral response for the visual appeal feature can be the same or different than the scoring of the Neutral response of the overall likeness feature of statement two.

In a third box 406, textual instructions (e.g., “Step 3: Provide Other Comments (Optional)”) inform the user as to what to do. For example, if the user appeal or lack of appeal is based on features not currently offered, the user can input this information in the third box 406.

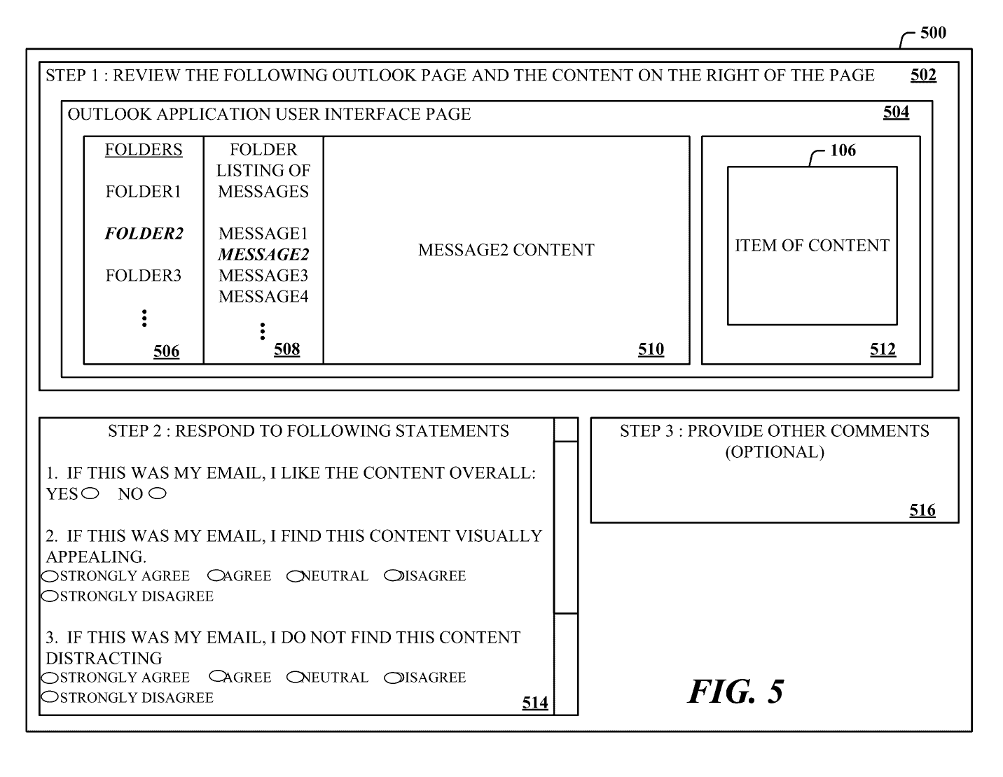

FIG. 5 illustrates an automatically-generated HIT visual 500 that can be created for a specific publisher application and submitted to the scoring pipeline 300 of FIG. 3. In this particular example, the publisher application can be an email program, Outlook, by Microsoft Corporation.

As in FIG. 4 above, but in a slightly different view (contextually within a UI of the publisher application Outlook), the task visual 500 presents three steps in three corresponding boxes the user is requested to complete for a given piece of content (e.g., content 106). The task visual 500 is organized to guide the user through the three steps in an ordered manner when handling the publisher UI.

In a first box 502, a user interface page 504 of the publisher application is presented. Since the UI page 504 relates to Outlook, the Outlook UI page 504 shows a folders section 506 in which various folders are listed and shown, a messages section 508 in which messages in the selected folder (Folder2) in the folders section 506 are listed, a message content window 510 in which email content is shown for the selected message (Message2) in the messages section 508, and a content section 510 in which the item of content 106 is presented for viewing by the user.

Additionally, the first box 502 includes textual instructions (e.g., “Step 1: Review the Following Outlook Page and the Content on the Right of the Page”) to instruct the user what to do. In this instance, the user is requested to review the UI page 504 as a whole, the sections (506, 508, 510, and 512), other graphics of the page (not shown here), and the item of content 106.

In a second box 514, one or more statements are presented for viewing and response (feedback) by the user. These statements relate to the features for which the designer or creator wants user feedback, and for the recommendation system, in general. Additionally, the second box 514 includes textual instructions (e.g., “Step 2: Respond to the Following Statements”) to instruct the user to respond to the statements.

In this instance, the task visual 500 requests user feedback on at least three statements that can be viewed here, two of which are global features: overall likeness (for statement one), visual appeal (for statement two), and distraction (for statement three). Other statements may be included in the second box 514; however, the user will need to scroll to view the other statements using a scroll bar.

In this particular implementation, the feedback for statement one is Yes or No for overall content likeability, and for statements two and three, in the form of five responses: Strongly Agree, Agree, Neutral, Disagree, and Strongly Disagree. Scoring can be computed for each response individually, or each response and associated feature combined. For example, the overall likeness feature of statement one can be weighted the same or differently than the distraction feature of statement three. Additionally, the scoring of the Neutral response for the visual appeal feature can be the same or different than the scoring of the Neutral response of the distraction feature of statement three.

In a third box 516, textual instructions (e.g., “Step 3: Provide Other Comments (Optional)”) inform the user as to what to do. For example, if the user appeal or lack of appeal is based on features not currently offered, the user can input this information in the third box 516.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

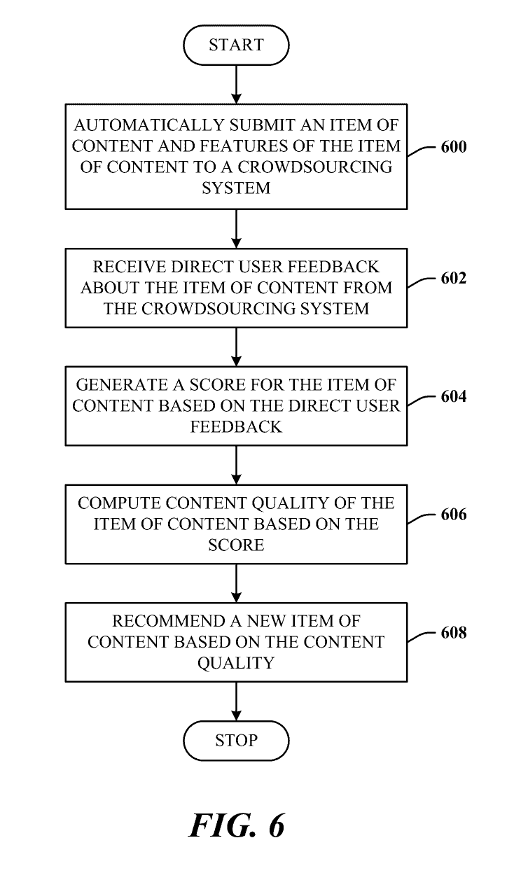

FIG. 6 illustrates a content recommendation method in accordance with the disclosed architecture. At 600, an item of content and features of the item of content are automatically submitted to a crowdsourcing system. At 602, direct user feedback about the item of content is received from the crowdsourcing system. That is, reviewers who choose to reply to the request for user input respond to the statements in the task visual. The score can be a consolidated score of all the scores for the features to which the crowdsourced users responded. Where only a single feature is requested for input, the score is the single score for the feature. At 604, a score for the item of content is generated based on the direct user feedback.

At 606, content quality of the item of content is computed based on the score. The score can be compared to a threshold value which indicates if the content should be eliminated or retained for serving by the content engine and/or use in the publisher application.

At 608, a new item of content is recommended based on the content quality. The recommendation can be based on the features to which reviewers responded favorably. In other words, if a certain color was reviewed favorably for the content, a certain media type was reviewed favorably for the content, the size of the content displayed was viewed favorably, and so on, it can be inferred using machine learning that similar content and content features will likely be viewed favorably.

The method can further comprise generating a task visual that identifies and presents to a reviewer(s) of the crowdsourcing system, features about the item of content of which reviewer response is requested. The method can further comprise generating a task visual as part of a publisher application user interface that embeds the item of content in the user interface and, identifies and presents to a reviewer(s) of the crowdsourcing system features about the item of content of which reviewer response is requested.

The method can further comprise signaling a content delivery engine to cease serving the item of content based on the content quality. The method can further comprise consolidating feature scores of the visual features to generate the score. The method can further comprise eliminating or retaining the item of content based on a feature score relative to a threshold.

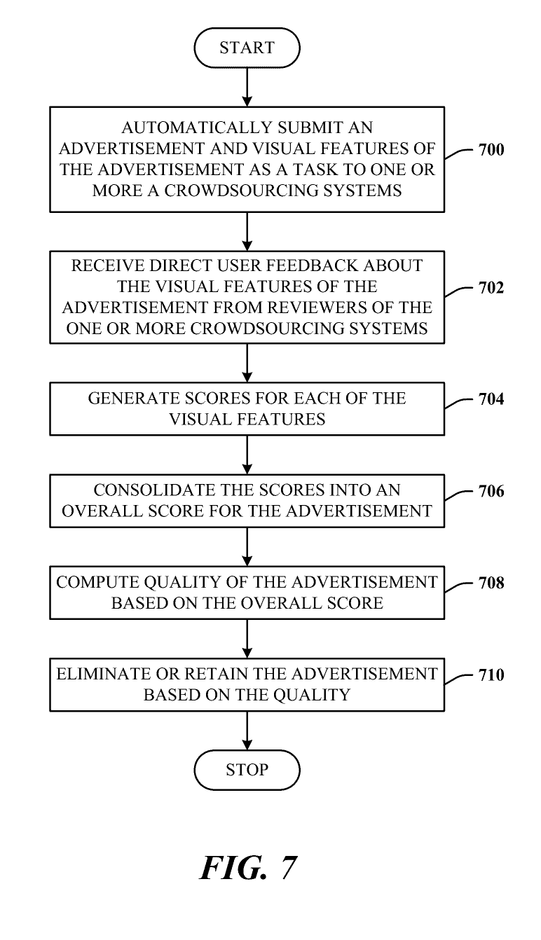

FIG. 7 illustrates an alternative method in accordance with the disclosed architecture. At 700, an advertisement and visual features of the advertisement are automatically submitting as a task to one or more crowdsourcing systems. At 702, direct user feedback about the visual features of the advertisement is received from reviewers of the one or more crowdsourcing systems. At 704, scores are generated for each of the visual features. At 706, the scores are consolidated into an overall score for the advertisement. At 708, quality of the advertisement is computed based on the overall score. At 710, the advertisement is eliminated or retained based on the quality.

The method can further comprise recommending a new advertisement based on the quality. The method can further comprise predicting ratings of each of the reviewers using machine learning or other techniques (e.g., linear regression and an optimization function). The method can further comprise adapting and embedding the advertisement in different publisher application contexts and predicting scores for new advertisements for a given reviewer. The method can further comprise selecting the visual features from at least one of a global level, local level, or a contextual level.

As used in this application, the term “component” is intended to refer to a computer-related entity, either hardware, a combination of software and tangible hardware, software, or software in execution. For example, a component can be, but is not limited to, tangible components such as one or more microprocessors, chip memory, mass storage devices (e.g., optical drives, solid state drives, magnetic storage media drives, etc.), computers, and portable computing and computing-capable devices (e.g., cell phones, tablets, smart phones, etc.). Software components include processes running on a microprocessor, an object (a software entity that maintains state in variables and behavior using methods), an executable, a data structure (stored in a volatile or a non-volatile storage medium), a module (a part of a program), a thread of execution (the smallest sequence of instructions that can be managed independently), and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

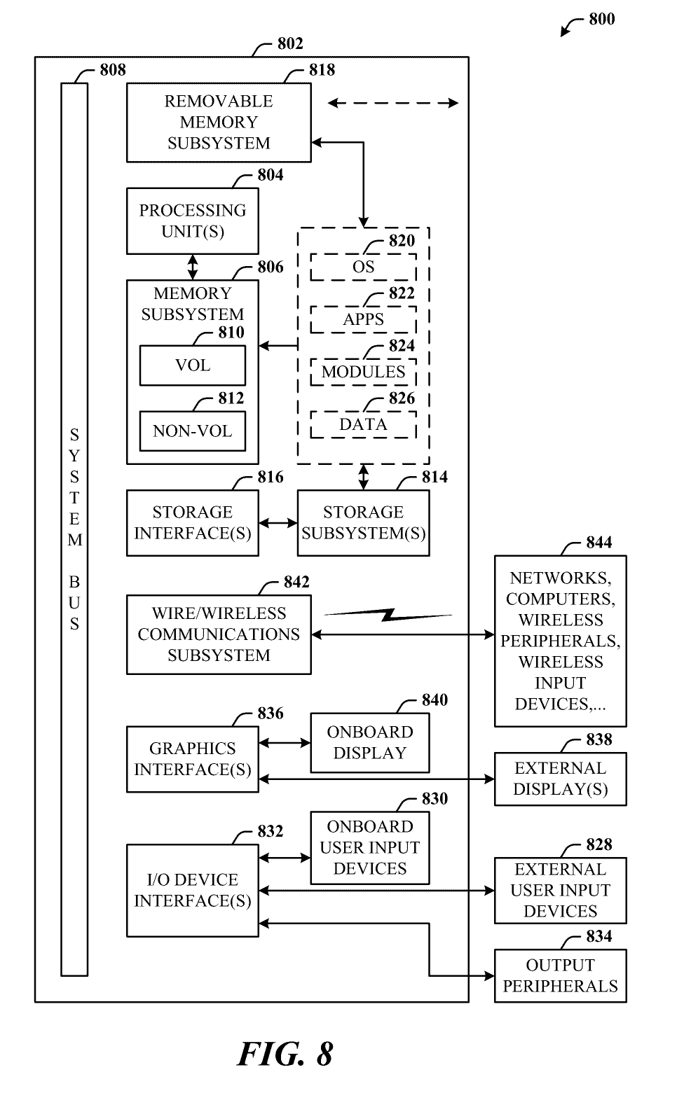

Referring now to FIG. 8, there is illustrated a block diagram of a computing system 800 that executes content recommendation in accordance with the disclosed architecture. Alternatively, or in addition, the functionally described herein can be performed, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), Complex Programmable Logic Devices (CPLDs), etc., where analog, digital, and/or mixed signals and other functionality can be implemented in a substrate.

In order to provide additional context for various aspects thereof, FIG. 8 and the following description are intended to provide a brief, general description of the suitable computing system 800 in which the various aspects can be implemented. While the description above is in the general context of computer-executable instructions that can run on one or more computers, those skilled in the art will recognize that a novel implementation also can be realized in combination with other program modules and/or as a combination of hardware and software.

The computing system 800 for implementing various aspects includes the computer 802 having microprocessing unit(s) 804 (also referred to as microprocessor(s) and processor(s)), a computer-readable storage medium (where the medium is any physical device or material on which data can be electronically and/or optically stored and retrieved) such as a system memory 806 (computer readable storage medium/media also include magnetic disks, optical disks, solid state drives, external memory systems, and flash memory drives), and a system bus 808. The microprocessing unit(s) 804 can be any of various commercially available microprocessors such as single-processor, multi-processor, single-core units and multi-core units of processing and/or storage circuits. Moreover, those skilled in the art will appreciate that the novel system and methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 802 can be one of several computers employed in a datacenter and/or computing resources (hardware and/or software) in support of cloud computing services for portable and/or mobile computing systems such as wireless communications devices, cellular telephones, and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 806 can include computer-readable storage (physical storage) medium such as a volatile (VOL) memory 810 (e.g., random access memory (RAM)) and a non-volatile memory (NON-VOL) 812 (e.g., ROM, EPROM, EEPROM, etc.). A basic input/output system (BIOS) can be stored in the non-volatile memory 812, and includes the basic routines that facilitate the communication of data and signals between components within the computer 802, such as during startup. The volatile memory 810 can also include a high-speed RAM such as static RAM for caching data.

The system bus 808 provides an interface for system components including, but not limited to, the system memory 806 to the microprocessing unit(s) 804. The system bus 808 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 802 further includes machine readable storage subsystem(s) 814 and storage interface(s) 816 for interfacing the storage subsystem(s) 814 to the system bus 808 and other desired computer components and circuits. The storage subsystem(s) 814 (physical storage media) can include one or more of a hard disk drive (HDD), a magnetic floppy disk drive (FDD), solid state drive (SSD), flash drives, and/or optical disk storage drive (e.g., a CD-ROM drive DVD drive), for example. The storage interface(s) 816 can include interface technologies such as EIDE, ATA, SATA, and IEEE 1394, for example.

One or more programs and data can be stored in the memory subsystem 806, a machine readable and removable memory subsystem 818 (e.g., flash drive form factor technology), and/or the storage subsystem(s) 814 (e.g., optical, magnetic, solid state), including an operating system 820, one or more application programs 822, other program modules 824, and program data 826.

The operating system 820, one or more application programs 822, other program modules 824, and/or program data 826 can include items and components of the system 100 of FIG. 1, features of FIG. 2, items, components, and flow of the scoring pipeline 300 of FIG. 3, the task visual 400 of FIG. 4, the task visual 500 of FIG. 5, and the methods represented by the flowcharts of FIGS. 6 and 7, for example.

Generally, programs include routines, methods, data structures, other software components, etc., that perform particular tasks, functions, or implement particular abstract data types. All or portions of the operating system 820, applications 822, modules 824, and/or data 826 can also be cached in memory such as the volatile memory 810 and/or non-volatile memory, for example. It is to be appreciated that the disclosed architecture can be implemented with various commercially available operating systems or combinations of operating systems (e.g., as virtual machines).

The storage subsystem(s) 814 and memory subsystems (806 and 818) serve as computer readable media for volatile and non-volatile storage of data, data structures, computer-executable instructions, and so on. Such instructions, when executed by a computer or other machine, can cause the computer or other machine to perform one or more acts of a method. Computer-executable instructions comprise, for example, instructions and data which cause a general purpose computer, special purpose computer, or special purpose microprocessor device(s) to perform a certain function or group of functions. The computer executable instructions may be, for example, binaries, intermediate format instructions such as assembly language, or even source code. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 802, and include volatile and non-volatile internal and/or external media that is removable and/or non-removable. For the computer 802, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 802, programs, and data using external user input devices 828 such as a keyboard and a mouse, as well as by voice commands facilitated by speech recognition. Other external user input devices 828 can include a microphone, an IR (infrared) remote control, a joystick, a game pad, camera recognition systems, a stylus pen, touch screen, gesture systems (e.g., eye movement, body poses such as relate to hand(s), finger(s), arm(s), head, etc.), and the like. The user can interact with the computer 802, programs, and data using onboard user input devices 830 such a touchpad, microphone, keyboard, etc., where the computer 802 is a portable computer, for example.

These and other input devices are connected to the microprocessing unit(s) 804 through input/output (I/O) device interface(s) 832 via the system bus 808, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 832 also facilitate the use of output peripherals 834 such as printers, audio devices, camera devices, and so on, such as a sound card and/or onboard audio processing capability.

One or more graphics interface(s) 836 (also commonly referred to as a graphics processing unit (GPU)) provide graphics and video signals between the computer 802 and external display(s) 838 (e.g., LCD, plasma) and/or onboard displays 840 (e.g., for portable computer). The graphics interface(s) 836 can also be manufactured as part of the computer system board.

The computer 802 can operate in a networked environment (e.g., IP-based) using logical connections via a wired/wireless communications subsystem 842 to one or more networks and/or other computers. The other computers can include workstations, servers, routers, personal computers, microprocessor-based entertainment appliances, peer devices or other common network nodes, and typically include many or all of the elements described relative to the computer 802. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 802 connects to the network via a wired/wireless communication subsystem 842 (e.g., a network interface adapter, onboard transceiver subsystem, etc.) to communicate with wired/wireless networks, wired/wireless printers, wired/wireless input devices 844, and so on. The computer 802 can include a modem or other means for establishing communications over the network. In a networked environment, programs and data relative to the computer 802 can be stored in the remote memory/storage device, as is associated with a distributed system. It will be appreciated that the network connections shown are exemplary and other means of establishing a communications link between the computers can be used.

The computer 802 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

The disclosed architecture can be implemented as a content recommendation system, comprising: means for automatically submitting an item of content and features of the item of content to a crowdsourcing system; means for receiving direct user feedback about the item of content from the crowdsourcing system; means for generating a score for the item of content based on the direct user feedback; means for computing content quality of the item of content based on the score; and, means for recommending a new item of content based on the content quality.

The disclosed architecture can be implemented as an alternative content recommendation system, comprising: means for automatically submitting an advertisement and visual features of the advertisement as a task to one or more a crowdsourcing systems; means for receiving direct user feedback about the visual features of the advertisement from reviewers of the one or more crowdsourcing systems; means for generating scores for each of the visual features; means for consolidating the scores into an overall score for the advertisement; means for computing quality of the advertisement based on the overall score; and, means for eliminating or retaining the advertisement based on the quality.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A content recommendation system, comprising:
a content features component configured to enable assignment of features to a piece of content;
a feedback component configured to automatically submit the piece of content and the features to a user feedback system and receive user feedback about the piece of content;
a scoring component configured to generate a score for the piece of content based on the user feedback;
a quality component configured to compute content quality of the piece of content based on the score; and
at least one hardware processor configured to execute computer-executable instructions in a memory, the instructions executed to enable the content features component, the feedback component, the scoring component, and the quality component.

2. The system of claim 1, wherein the scoring component is configured to score the piece of content based on various features.

3. The system of claim 1, wherein the feedback component submits the piece of content in an application user interface in which the piece of content can be used.

4. The system of claim 1, wherein the feedback component submits the piece of content to the user feedback system and one or more other user feedback systems.

5. The system of claim 1, wherein the content features component is configured to consider application-centric features of an application user interface in which the piece of content can be displayed.

6. The system of claim 1, wherein the content quality is interpreted to eliminate lower quality content and retain higher quality content.

7. The system of claim 1, wherein the content features comprise at least one of global features that represent overall content quality, local features that represent specific parts within a given user interface, or contextual features that represent visual features in context of a publisher application.

8. The system of claim 1, wherein the user feedback system enables the user feedback via at least one of direct user feedback and crowdsourced user feedback.

9. The system of claim 1, further comprising a score consolidation component configured to consolidate feature scores of the features and to generate the score.

10. A content recommendation method, comprising acts of:
automatically submitting an item of content and features of the item of content to a crowdsourcing system;
receiving direct user feedback about the item of content from the crowdsourcing system;
generating a score for the item of content based on the direct user feedback;
computing content quality of the item of content based on the score; and
recommending a new item of content based on the content quality.

11. The method of claim 10, further comprising generating a task visual that identifies and presents to a reviewer of the crowdsourcing system features about the item of content of which reviewer response is requested.

12. The method of claim 10, further comprising generating a task visual as part of a publisher application user interface that embeds the item of content in the user interface and, identifies and presents to a reviewer of the crowdsourcing system features about the item of content of which reviewer response is requested.

13. The method of claim 10, further comprising signaling a content delivery engine to cease serving the item of content based on the content quality.

14. The method of claim 10, further comprising consolidating feature scores of the visual features to generate the score.

15. The method of claim 10, further comprising eliminating or retaining the item of content based on a feature score relative to a threshold.

16. A content recommendation method, comprising acts of:
automatically submitting an advertisement and visual features of the advertisement as a task to one or more a crowdsourcing systems;
receiving direct user feedback about the visual features of the advertisement from reviewers of the one or more crowdsourcing systems;
generating scores for each of the visual features;
consolidating the scores into an overall score for the advertisement;
computing quality of the advertisement based on the overall score; and
eliminating or retaining the advertisement based on the quality.

17. The method of claim 16, further comprising recommending a new advertisement based on the quality.

18. The method of claim 16, further comprising predicting ratings of each of the reviewers using machine learning.

19. The method of claim 16, further comprising adapting and embedding the advertisement in different publisher application contexts and predicting scores for new advertisements for a given reviewer.

20. The method of claim 16, further comprising selecting the visual features from at least one of a global level, local level, or a contextual level.
